(19) United States
(12) Patent Application Publication
(10) Pub. No.: US 2024/0274835 A1
(43) Pub. Date: Aug. 15, 2024

(54) PREPARATION METHOD AND APPLICATION OF SELF-HEALING CONDUCTIVE COATING MODIFIED BIPOLAR CURRENT COLLECTOR THEREOF

(71) Applicant: DONGJIANG ENVIRONMENTAL COMPANY LIMITED, Shenzhen, Guangdong (CN)

(72) Inventors: Shanshan ZENG, Shenzhen, Guangdong (CN); Junqiang ZHU, Shenzhen, Guangdong (CN); Zongwen ZHAO, Shenzhen, Guangdong (CN); Zengmeng YU, Shenzhen, Guangdong (CN); Wenbin XU, Shenzhen, Guangdong (CN)

(21) Appl. No.: 18/567,701

(22) PCT Filed: Dec. 31, 2021
(86) PCT No.: PCT/CN2021/143709

§ 371 Date: Dec. 6, 2023

(51) Int. Cl. H01M 4/66; H01M 4/75; H01M 10/0525

(52) U.S. Cl. CPC H01M 4/667; H01M 4/661; H01M 4/668; H01M 4/75; H01M 10/0525

(57) ABSTRACT

The present disclosure relates to the field of battery technologies and in particular to a bipolar current collector modified by a self-healing conductive coating and a preparation method and application thereof. The key points in the technical scheme are as follows: the method includes: preparing microcapsules containing a healing agent; preparing a slurry containing the microcapsules, a catalyst, an adhesive and a conductive filler; coating the slurry on a surface of a current collector substrate to obtain a bipolar current collector with a self-healing conductive coating. in a case of occurrence of perforation of the current collector, the self-healing microcapsules in the self-healing conductive coating may crack under an external stress and the healing agent is released and can immediately perform polymerization reaction under the action of a catalyst to generate a self-heating material which can quickly and accurately repair the cracks or holes on the current collector layer.

### CROSS-REFERENCE TO RELATED APPLICATION

This application is a national stage application of PCT/CN2021/143709. This application claims priority from PCT Application No. PCT/CN2021/143709, filed Dec. 31, 2021, the content of which is incorporated herein in the entirety by reference.

### TECHNICAL FIELD

The present disclosure relates to the field of battery technologies and in particular to a bipolar current collector modified by a self-healing conductive coating and a preparation method and application thereof.

### BACKGROUND

Conventional lithium ion batteries usually adopt an inner-parallel-outer-series structure to achieve high voltage, which may increase the weight of a tab, and reduce battery energy density and efficiency at the time of group formation. Therefore, it is highly advantageous to prepare a high voltage battery by inner series-connection. However, the current collectors of the inner-series-connected high voltage batteries at present usually employ a very thin copper aluminum composite foil film to which a very tiny crack or hole may occur, leading to leakage of electrolyte. At these defects, ion and electron transportations are present, which may result in internal short-circuiting, greatly deteriorating the electric performance and safety performance of the electric core. At present, a common solution is to prepare a polymer-metal composite current collector. But, over a long time of use, electrolyte seeping into the metal penetrating cracks or holes may still seep out from the metal-polymer interfaces, leading to internal short-circuiting of the batteries.

### SUMMARY

In order to address the shortcomings of the prior arts, the present disclosure provides a bipolar current collector modified by a self-healing conductive coating, and a preparation method and an application thereof. In the case of penetrating cracks or holes in the current collector, the self-healing coating can achieve self-healing on the current collector. This coating can effectively block the passage of an electrolyte so as to avoid internal short-circuiting within a battery.

The above technical object of the present disclosure is achieved by the following technical scheme: there is provided a bipolar current collector modified by a self-healing conductive coating, which includes:
a current collector substrate, where a surface of the current collector substrate is coated with the self-healing conductive coating.

In one example, the current collector substrate includes one or more of an aluminum foil, a copper foil, a nickel foil, a stainless steel foil, an aluminum-nickel composite foil and an aluminum-copper composite foil, and the current collector substrate has a thickness of 5 to 30 μm.

In one example, the self-healing conductive coating is a mixture of a self-healing material, an adhesive and a conductive filler, and the self-healing conductive coating has a coating thickness of 2 to 10 μm.

There is provided a method of preparing a bipolar current collector modified by a self-healing conductive coating, which includes the following steps:
preparing microcapsules containing a healing agent;
preparing a slurry containing the microcapsules, a catalyst, an adhesive and a conductive filler;
coating the slurry on a surface of a current collector substrate to obtain a bipolar current collector with a self-healing conductive coating.

In one example, in the step of preparing the slurry containing the microcapsules, the catalyst, the adhesive and the conductive filler, the conductive filler is one or more of titanium powder, copper powder, aluminum powder, silver powder, lithium-rich silicon powder, and lithium-rich tin powder, or one or more of carbon black, carbon nanotube, carbon fiber, and graphene.

In one example, in the step of preparing the slurry containing the microcapsules, the catalyst, the adhesive and the conductive filler, the adhesive is one or more of polyvinyl chloride, polyethylene, polypropylene, polystyrene, polytetrafluoroethylene, polyester terephthalate, polyamide, polyimide, polyether nitrile, polymethyl acrylate, polyvinylidene fluoride, polyurethane, polyacrylonitrile, styrene butadiene rubber, nitrile rubber, sodium carboxymethylcellulose, modified polyolefin, polyacetylene, polypyrrole and its derivatives, polythiophene and its derivatives, polyaniline and its derivatives, poly (p-phenylene vinylene) and its derivatives, polyparaphenylene and its derivatives, and polyfluorene and its derivatives.

In one example, in the step of preparing the slurry containing the microcapsules, the catalyst, the adhesive, and the conductive filler, the catalyst comprises one of molybdenum Schrock catalyst, ruthenium Grubbs catalyst, triethyl borane, diethylenetriamine, complex compound of copper bromide and 2-methylimidazole, scandium trifluoromethanesulfonate, tungsten hexachloride, and sodium dibutyl tin dilaurate.

In one example, in the step of preparing the microcapsules containing the healing agent, the healing agent includes one or more of cyclic olefin, lactone imine, acrylic acid, methacrylate, styrene, isoprene, 4,4′-methylenebis(phenyl isocyanate)/dicyclopentadiene and butadiene.

In one example, in the step of preparing the microcapsules containing the healing agent, a method of synthesizing the microcapsules comprises a chemical method, a physicochemical method, and a physical and mechanical method.

In one example, in the step of preparing the slurry containing the microcapsules, the catalyst, the adhesive, and the conductive filler, a mass ratio of the microcapsules, the catalyst, the adhesive and the conductive filler is (5 to 30):(0.1 to 5):(5 to 30):(30 to 70).

In one example, in the step of preparing the microcapsules containing the healing agent, the microcapsules have a particle size of 0.5 to 20 μm which consist of a capsule wall and a healing agent, wherein the capsule wall has a thickness of 1 to 5 μm.

In one example, in the step of preparing the microcapsules containing the healing agent, the capsule wall of the microcapsules is prepared by using polyamine, polyamide, polysulfonamide, polycarbonate, polyether, polyimide, phenolic resin, urea resin, polyurethane, polyolefin, polysilane, tetraethoxysilane, melamine-formaldehyde resin, and phenyl isocyanate.

There is provided a battery, which includes the above bipolar current collector or the bipolar current collector prepared by the above method.

The above bipolar current collector modified by a self-healing conductive coating and the preparation method and application thereof have the following beneficial effects.

In a case of the occurrence of perforation of the current collector, the self-healing microcapsules in the self-healing conductive coating may crack under external stress, and the healing agent is released and can immediately perform polymerization reaction under the action of a catalyst to generate a self-heating material which can quickly and accurately repair the cracks or holes on the current collector layer, so as to block seepage of electrolyte, avoiding the occurrence of short circuiting in the battery, and hence improving the safety of the battery.

### BRIEF DESCRIPTIONS OF THE DRAWINGS

FIG. 1 is a structural schematic diagram of an example.

FIG. 2 is a schematic diagram illustrating a self-healing process of a bipolar current collector modified by a self-healing conductive coating.

FIG. 3 is a diagram illustrating voltage capacities of perforated and un-perforated current collectors.

The numerals of the drawings are described below: 10. positive pole material layer, 20. current collector layer, 21. self-healing capsule, 22. catalyst, 23. conductive agent, 24. adhesive, 25. current collector substrate, 30. negative pole material layer, 40. hole, 50. self-healing material.

### DETAILED DESCRIPTIONS OF EMBODIMENTS

The present disclosure will be detailed below in combination with drawings and specific examples.

In the descriptions of the present disclosure, it is understood that orientation or positional relationship indicated by the terms such as “central”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, “axial”, “radial”, and “circumferential” is used only for ease of descriptions and does not indicate or imply that the indicated devices or elements must have a particular orientation, or be constructed or operated in a particular orientation. Therefore, such terms shall not be understood as limiting of the present disclosure.

Further, the terms “first” and “second” are used for descriptions only and shall not be understood as indicating or implying relative importance or implicitly indicating the number of the indicated features. As a result, the features defined by “first” and “second” may explicitly or implicitly include at least one feature. In the descriptions of the present disclosure, “several” refers to at least two, for example, two or three or the like, unless otherwise clearly stated.

In the present disclosure, unless otherwise clearly stated or defined, the terms “mount”, “connect”, “couple”, and “fix” and the like shall be understood in a broad sense, for example, may be fixed connection, or detachable connection, or formed into one piece; or may be a mechanical connection, or electrical connection; or direct connection or an indirect connection through an intermediate medium, or may be internal communication between two elements or mutual interaction of two elements, unless otherwise stated. Those skilled in the art may understand the specific meanings of the above terms in the present disclosure according to actual situations.

In the present disclosure, unless otherwise clearly stated or defined, the first feature being “on” or “below” the second feature refers to that the first feature and the second feature are in direct contact, or the first feature and the second feature are in indirect contact through an intermediate medium. Furthermore, the first feature being “above” or “on” the second feature refers to that the first feature is exactly above or obliquely above the second feature, or only refers to that the first feature has a higher horizontal height than the second feature. The first feature being “under” or “below” the second feature refers to that the first feature is exactly under or obliquely below the second feature, or only refers to that the first feature has a smaller horizontal height than the second feature.

The present disclosure provides a bipolar current collector modified by a seal-healing conductive coating, including:

a current collector substrate, where a surface of the current collector substrate is coated with the seal-healing conductive coating.

Preferably, the current collector substrate includes one or more of an aluminum foil, a copper foil, a nickel foil, a stainless steel foil, an aluminum-nickel composite foil and an aluminum-copper composite foil, and the current collector substrate has a thickness of 5 to 30 μm.

Preferably, the self-healing conductive coating is a mixture of a self-healing material, an adhesive and a conductive filler, and the self-healing conductive coating has a coating thickness of 2 to 10 μm.

The present disclosure provides a method of preparing a bipolar current collector modified by a self-healing conductive coating, which includes the following steps:
preparing microcapsules containing a healing agent;
preparing a slurry containing the microcapsules, a catalyst, an adhesive and a conductive filler;
coating the slurry on a surface of a current collector substrate to obtain a bipolar current collector with a self-healing conductive coating.

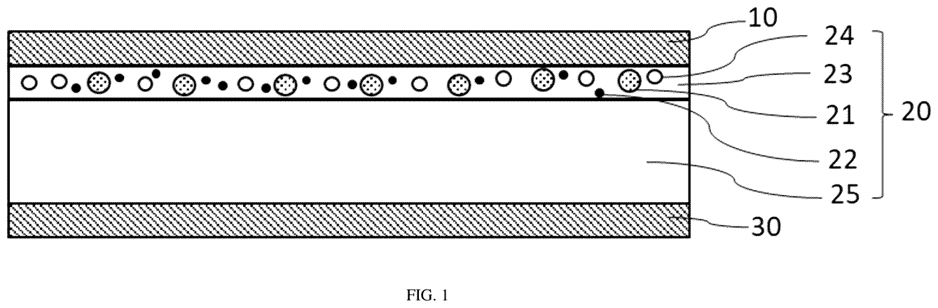

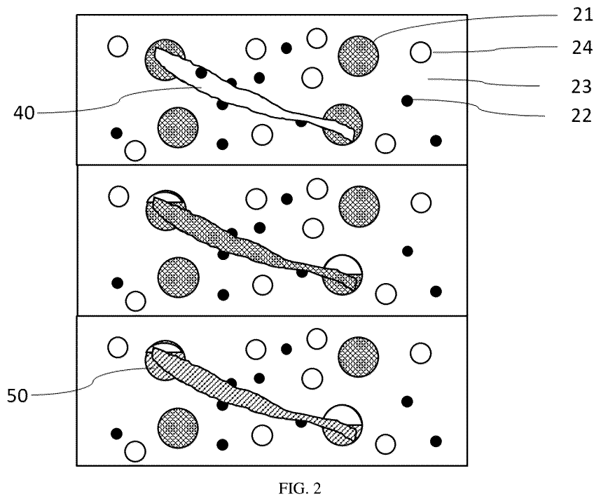

The structure of the bipolar current collector prepared by the above method is shown in FIG. 1. The bipolar current collector sequentially includes, from top down, a positive pole material layer 10, a current collector layer 20, and a negative pole material layer 30. The current collector layer 20 includes a current collector substrate 25 and a self-healing conductive coating. The self-healing conductive coating includes self-healing microcapsules 21, a catalyst 22, an adhesive 24, and a conductive agent 23. FIG. 2 shows a schematic diagram illustrating a self-healing process of a bipolar current collector modified by a self-healing conductive coating. When a penetrating crack or hole 40 occurs on the current collector substrate 25, the self-healing microcapsules 21 may crack under external stress to release the healing agent in the self-healing microcapsules 21. Under the action of the catalyst 22, the healing agent may immediately perform a polymerization reaction to generate a self-healing material 50 which can quickly and accurately repair the crack or hole 40 on the current collector layer 20 to block seepage of electrolyte, thus avoiding short-circuiting in a battery and improving the safety of the battery.

Preferably, the conductive filler is one or more of titanium powder, copper powder, aluminum powder, silver powder, lithium-rich silicon powder, and lithium-rich tin powder, or one or more of carbon black, carbon nanotube, carbon fiber, and graphene.

Preferably, the adhesive is one or more of polyvinyl chloride, polyethylene, polypropylene, polystyrene, polytetrafluoroethylene, polyester terephthalate, polyamide, polyimide, polyether nitrile, polymethyl acrylate, polyvinylidene fluoride, polyurethane, polyacrylonitrile, styrene butadiene rubber, nitrile rubber, sodium carboxymethylcellulose, modified polyolefin, polyacetylene, polypyrrole and its derivatives, polythiophene and its derivatives, polyaniline and its derivatives, poly (p-phenylene vinylene) and its derivatives, polyparaphenylene and its derivatives, and polyfluorene and its derivatives.

Preferably, in the step of preparing the slurry containing the microcapsules, the catalyst, the adhesive, and the conductive filler, the catalyst includes one of molybdenum Schrock catalyst, ruthenium Grubbs catalyst, triethyl borane, diethylenetriamine, complex compound of copper bromide and 2-methylimidazole, scandium trifluoromethanesulfonate, tungsten hexachloride, and sodium dibutyl tin dilaurate.

Preferably, the healing agent includes one or more of cyclic olefin, lactone imine, acrylic acid, methacrylate, styrene, isoprene, 4,4′-methylenebis(phenyl isocyanate)/dicyclopentadiene and butadiene.

Preferably, a method of synthesizing the microcapsules includes a chemical method such as interfacial polycondensation, in situ polymerization, and the like; a physicochemical method such as complex coacervation, and melting dispersion condensation and the like; and a physical and mechanical method, such as air suspension film formation and spray method and the like.

Preferably, a mass ratio of the microcapsules, the catalyst, the adhesive, and the conductive filler is (5 to 30):(0.1 to 5):(5 to 30):(30 to 70).

Preferably, the microcapsules have a particle size of 0.5 to 20 μm, which consist of a capsule wall and a healing agent, where the capsule wall has a thickness of 1 to 5 μm.

Preferably, the capsule wall of the microcapsules is prepared by using polyamine, polyamide, polysulfonamide, polycarbonate, polyether, polyimide, phenolic resin, urea resin, polyurethane, polyolefin, polysilane, tetraethoxysilane, melamine-formaldehyde resin, and phenyl isocyanate.

The present disclosure further provides a battery including the above bipolar current collector or the bipolar current collector prepared by the above method.

Further descriptions will be made below with specific examples.

### Example 1

The example provides a self-healing conductive bipolar current collector, which includes an aluminum foil and a self-healing conductive coating. The self-healing conductive coating is coated double-sidedly to the surface of the aluminum foil. The self-healing conductive coating is formed of phenyl isocyanate/bisphenol A epoxy resin microcapsules, sodium dibutyl tin dilaurate catalyst, polyethylene, and titanium powder. The method of preparing the self-healing conductive bipolar current collector includes the following steps:

By using interfacial polycondensation, 4,4′-methylenebis(phenyl isocyanate)/dicyclopentadiene self-healing microcapsules were synthesized.

20 parts of 4,4′-methylenebis(phenyl isocyanate)/bisphenol A epoxy resin microcapsules, 5 parts of sodium dibutyl tin dilaurate catalyst, 5 parts of polyethylene, and 50 parts of titanium powder were weighed and then added into a toluene solution. After one material was added to the solution, it should be stirred uniformly before another material was added. In this way, a homogeneous and stable slurry was obtained finally.

The obtained slurry was coated on both side surfaces of the aluminum foil, where the self-healing conductive coating had a thickness of 3 μm. After drying, a bipolar current collector with double-sided self-healing conductive coating was obtained.

The preparation method of a lithium-ion battery is described below.

A positive pole active material LiNi_{0.8}Co_{0.1}Mn_{0.1}O₂ was coated on a side of the above self-healing conductive bipolar current collector and then dried, rolled, and cut and then a lithium steel alloy was overlaid on the other side of the above self-healing conductive bipolar current collector, so as to prepare a bipolar sheet.

Four bipolar sheets were overlaid each other, which were separated by a solid state electrolyte film, lithium, germanium, phosphorus, and sulfur therebetween, and then compacted and then packaged with an aluminum plastic film so as to obtain an inner-series-connected solid state lithium ion battery. The solid state electrolyte film lithium, germanium, phosphorus, and sulfur refers to a uniform slurry formed by stirring lithium, germanium, phosphorus, sulfur powder, and polyvinylidene fluoride in a toluene solution. Then, the slurry was coated on a surface of polyethylene terephthalate thin film (PET thin film) to form a film which was dried under a vacuum to form the solid state electrolyte film. A mass ratio of the lithium, germanium, phosphorus, and sulfur powder to polyvinylidene fluoride was 95:5.

### Example 2

The present example provides a self-healing conductive bipolar current collector, which includes a copper foil and a self-healing conductive coating, where the self-healing conductive coating is coated single-sidedly on the surface of the copper foil. The self-healing conductive coating is formed of urea resin/dicyclopentadiene microcapsules, a Grubbs catalyst, a nitrile rubber, and a carbon black. The method of preparing the self-healing conductive bipolar current collector includes the following steps.

By in situ polymerization, urea resin/dicyclopentadiene microcapsules were self-healing synthesized.

5 parts of urea resin/dicyclopentadiene microcapsules, 0.1 parts of Grubbs catalyst, 5 parts of nitrile rubber, and 30 parts of carbon black were weighed and then added sequentially into a toluene solution. After one material was added to the solution, it should be stirred uniformly before another material was added. In this way, a homogeneous and stable slurry was obtained finally.

The obtained slurry was coated on one side surface of the copper foil, where the self-healing conductive coating had a thickness of 2 μm. After drying, a bipolar current collector with single-sided self-healing conductive coating was obtained.

The preparation method of a lithium-ion battery is described below.

A positive pole active material LiNi_{0.8}Co_{0.1}Mn_{0.1}O₂ was coated on a side modified by a self-healing conductive coating on the above self-healing conductive bipolar current collector, and then dried, rolled, and cut and then a negative pole material lithium indium alloy was overlaid on the other side of the above self-healing conductive bipolar current collector, so as to prepare a bipolar sheet.

Four bipolar sheets were overlaid each other, which were separated by a solid state electrolyte film of lithium, germanium, phosphorus, and sulfur therebetween, and then compacted and then packaged with an aluminum plastic film so as to obtain an inner-series-connected solid state lithium ion battery. The preparation method of the solid state electrolyte film lithium, germanium, phosphorus, and sulfur is the same as in example 1.

### Example 3

The present example provides a self-healing conductive bipolar current collector which includes a copper foil and a self-healing conductive coating, where the self-healing conductive coating is coated double-sidedly on the surface of the copper foil. The self-healing conductive coating is formed of melamine-formaldehyde/bisphenol F epoxy resin microcapsules, a diethylenetriamine catalyst, polymethyl acrylate, and a carbon nanotube. The method of preparing the self-healing conductive bipolar current collector includes the following steps.

By the in situ polymerization, melamine-formaldehyde/bisphenol F epoxy resin microcapsules were prepared.

5 parts of melamine-formaldehyde/bisphenol F epoxy resin microcapsules, 0.5 parts of diethylenetriamine catalyst, 20 parts of polymethyl acrylate, and 50 parts of carbon nanotube were weighed and then added sequentially into a toluene solution. After one material was added to the solution, it should be stirred uniformly before another material was added. In this way, a homogeneous and stable slurry was obtained finally.

The obtained slurry was coated on double side surfaces of the copper foil, where the self-healing conductive coating had a thickness of 3 μm. After drying, a bipolar current collector with double-sided self-healing conductive coating was obtained.

The preparation method of a lithium-ion battery is described below.

A positive pole active material LiNi_{0.8}Co_{0.1}Mn_{0.1}O₂ was coated on a side of the above self-healing conductive bipolar current collector and then dried, rolled, and cut and then a lithium steel alloy was overlaid on the other side of the above self-healing conductive bipolar current collector, so as to prepare a bipolar sheet.

Four bipolar sheets were overlaid each other, which were separated by a solid state electrolyte film of lithium, germanium, phosphorus, and sulfur therebetween, and then compacted and then packaged with an aluminum plastic film so as to obtain an inner-series-connected solid state lithium ion battery. The preparation method of the solid state electrolyte film lithium, germanium, phosphorus, and sulfur is the same as in example 1.

### Example 4

The present example provides a self-healing conductive bipolar current collector which includes an aluminum foil and a self-healing conductive coating, where the self-healing conductive coating is coated single-sidedly on the surface of the aluminum foil. The self-healing conductive coating is formed of gelatin/dicyclopentadiene microcapsules, a tungsten hexachloride catalyst, sodium carboxymethylcellulose, and graphene. The method of preparing the self-healing conductive bipolar current collector includes the following steps.

By using the spray method, gelatin/bisphenol A epoxy resin microcapsules were prepared.

30 parts of gelatin/bisphenol A epoxy resin microcapsules, 0.4 parts of tungsten hexachloride catalyst, 30 parts of sodium carboxymethylcellulose, and 70 parts of graphene were weighed and then added sequentially into a toluene solution. After one material was added to the solution, it should be stirred uniformly before another material was added. In this way, a homogeneous and stable slurry was obtained finally.

The obtained slurry was coated on one side surface of the aluminum foil, where the self-healing conductive coating had a thickness of 5 μm. After drying, a bipolar current collector with single-sided self-healing conductive coating was obtained.

The preparation method of a lithium-ion battery is described below.

A positive pole active material LiNi_{0.8}Co_{0.1}Mn_{0.1}O₂ was coated on a side modified by a self-healing conductive coating on the above self-healing conductive bipolar current collector, and then dried, rolled, and cut and then a negative pole material lithium steel alloy was overlaid on the other side of the above self-healing conductive bipolar current collector, so as to prepare a bipolar sheet.

Four bipolar sheets were overlaid each other, which were separated by a solid state electrolyte film of lithium, germanium, phosphorus, and sulfur therebetween, and then compacted and then packaged with an aluminum plastic film so as to obtain an inner-series-connected solid state lithium ion battery. The preparation method of the solid state electrolyte film lithium, germanium, phosphorus, and sulfur is the same as in example 1.

### Example 5

The present example provides a self-healing conductive bipolar current collector which includes an aluminum copper composite foil and a self-healing conductive coating, where the self-healing conductive coating is coated double-sidedly on the surface of the aluminum copper composite foil. The self-healing conductive coating is formed of alginic acid/bisphenol A epoxy glyceryl ether microcapsules, scandium trifluoromethanesulfonate, polyimide, and carbon fiber. The alginic acid/bisphenol A epoxy glyceryl ether microcapsules are prepared by the above method. The method of preparing the self-healing conductive bipolar current collector includes the following steps.

20 parts of alginic acid/bisphenol A epoxy glyceryl ether microcapsules, 2 parts of scandium trifluoromethanesulfonate catalyst, 5 parts of styrene butadiene rubber, and 50 parts of carbon fiber were weighed and added sequentially into a toluene solution. After one material was added to the solution, it should be stirred uniformly before another material was added. In this way, a homogeneous and stable slurry was obtained finally.

The obtained slurry was coated on both side surfaces of the aluminum copper composite foil, where the self-healing conductive coating had a thickness of 10 μm. After drying, a bipolar current collector with double-sided self-healing conductive coating was obtained.

The preparation method of a lithium-ion battery is described below.

A positive pole active material LiNi_{0.8}Co_{0.1}Mn_{0.1}O₂ was coated on a side of the above self-healing conductive bipolar current collector and then dried, rolled, and cut and then a lithium indium alloy was overlaid on the other side of the above self-healing conductive bipolar current collector, so as to prepare a bipolar sheet.

Four bipolar sheets were overlaid each other, which were separated by a solid state electrolyte film of lithium, germanium, phosphorus, and sulfur therebetween, and then compacted and then packaged with an aluminum plastic film so as to obtain an inner-series-connected solid state lithium ion battery. The preparation method of the solid state electrolyte film lithium, germanium, phosphorus, and sulfur is the same as in example 1.

### Charge and Discharge Test

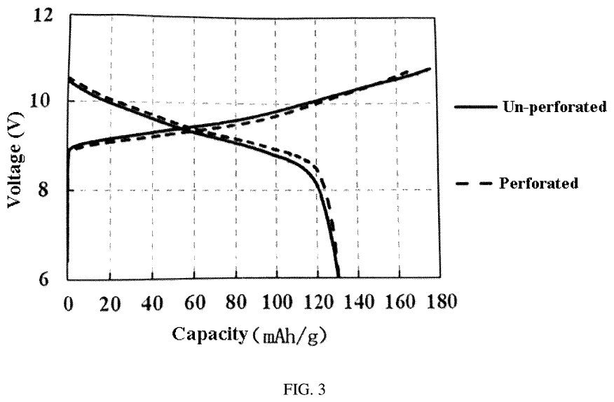

The self-healing conductive bipolar current collector prepared in example 1 was perforated, and then the perforated self-healing conductive bipolar current collector and an un-perforated self-healing conductive bipolar current collector were respectively assembled into a battery by using the preparation method of the lithium ion battery in example 1 to undergo constant current charge and discharge test, such that the test batteries were initially charged and discharged with a charge and discharge voltage range of 6 to 10.8V and a current density of 10 mA/g under normal temperature. The test result is as shown in FIG. 3. It can be known from the test result of the above FIG. 3 that the charge and discharge performances of the batteries with the perforated and un-perforated current collectors do not differ greatly. The reason for this is as follows: in a case of the occurrence of perforation of the current collector, the self-healing microcapsules in the self-healing conductive coating may crack under external stress, and the healing agent is released and can immediately perform a polymerization reaction under the action of a catalyst to generate a self-heating material which can quickly and accurately repair the cracks or holes on the current collector layer, so as to block seepage of electrolyte, avoiding the occurrence of short circuiting in the battery, and hence improving the safety of the battery.

The above examples are only illustrative and used to interpret some features of the method of the present disclosure. The appended claims are intended to claim a scope conceived of as widely as possible, and the examples mentioned in the present disclosure are those in which true test results of the applicant are demonstrated. Therefore, the applicant desires that the appended claims are not limited by the selection of the examples describing the features of the present disclosure. Some numerical ranges used in the claims also include sub-ranges within them and the changes of these ranges shall also be, in possible cases, interpreted as covered by the appended claims.

1. A bipolar current collector modified by a seal-healing conductive coating, comprising:
a current collector substrate, wherein a surface of the current collector substrate is coated with the seal-healing conductive coating.

2. The bipolar current collector of claim 1, wherein the current collector substrate comprises one or more of an aluminum foil, a copper foil, a nickel foil, a stainless steel foil, an aluminum-nickel composite foil and an aluminum-copper composite foil, and the current collector substrate has a thickness of 5 to 30 μm.

3. The bipolar current collector of claim 1, wherein the self-healing conductive coating is a mixture of a self-healing material, an adhesive and a conductive filler, and the self-healing conductive coating has a coating thickness of 2 to 10 μm.

4. A method of preparing a bipolar current collector modified by a self-healing conductive coating, comprising the following steps:
preparing microcapsules containing a healing agent;
preparing a slurry containing the microcapsules, a catalyst, an adhesive and a conductive filler;
coating the slurry on a surface of a current collector substrate to obtain a bipolar current collector with a self-healing conductive coating.

5. The method of claim 4, wherein in the step of preparing the slurry containing the microcapsules, the catalyst, the adhesive and the conductive filler, the conductive filler is one or more of titanium powder, copper powder, aluminum powder, silver powder, lithium-rich silicon powder, and lithium-rich tin powder, or one or more of carbon black, carbon nanotube, carbon fiber, and graphene.

6. The method of claim 4, wherein, in the step of preparing the slurry containing the microcapsules, the catalyst, the adhesive and the conductive filler, the adhesive is one or more of polyvinyl chloride, polyethylene, polypropylene, polystyrene, polytetrafluoroethylene, polyester terephthalate, polyamide, polyimide, polyether nitrile, polymethyl acrylate, polyvinylidene fluoride, polyurethane, polyacrylonitrile, styrene butadiene rubber, nitrile rubber, sodium carboxymethylcellulose, modified polyolefin, polyacetylene, polypyrrole and its derivatives, polythiophene and its derivatives, polyaniline and its derivatives, poly (p-phenylene vinylene) and its derivatives, polyparaphenylene and its derivatives, and polyfluorene and its derivatives.

7. The method of claim 4, wherein in the step of preparing the slurry containing the microcapsules, the catalyst, the adhesive, and the conductive filler, the catalyst comprises one of molybdenum Schrock catalyst, ruthenium Grubbs catalyst, triethyl borane, diethylenetriamine, complex compound of copper bromide and 2-methylimidazole, scandium trifluoromethanesulfonate, tungsten hexachloride, and sodium dibutyl tin dilaurate.

8. The method of claim 4, wherein, in the step of preparing the microcapsules containing the healing agent, the healing agent comprises one or more of cyclic olefin, lactone imine, acrylic acid, methacrylate, styrene, isoprene, 4,4′-methylenebis(phenyl isocyanate)/dicyclopentadiene and butadiene.

9. The method of claim 4, wherein in the step of preparing the microcapsules containing the healing agent, a method of synthesizing the microcapsules comprises a chemical method, a physicochemical method, and a physical and mechanical method.

10. The method of claim 4, wherein in the step of preparing the slurry containing the microcapsules, the catalyst, the adhesive, and the conductive filler, a mass ratio of the microcapsules, the catalyst, the adhesive and the conductive filler is (5 to 30):(0.1 to 5):(5 to 30):(30 to 70).

11. The method of claim 4, wherein, in the step of preparing the microcapsules containing the healing agent, the microcapsules has a particle size of 0.5 to 20 μm which consist of a capsule wall and a healing agent, wherein the capsule wall has a thickness of 1 to 5 μm.

12. The method of claim 4, wherein in the step of preparing the microcapsules containing the healing agent, the capsule wall of the microcapsules is prepared by using polyamine, polyamide, polysulfonamide, polycarbonate, polyether, polyimide, phenolic resin, urea resin, polyurethane, polyolefin, polysilane, tetraethoxysilane, melamine-formaldehyde resin, and phenyl isocyanate.

13. A battery, comprising the bipolar current collector according to claim 1.

14. The battery of claim 13, wherein the current collector substrate comprises one or more of an aluminum foil, a copper foil, a nickel foil, a stainless steel foil, an aluminum-nickel composite foil and an aluminum-copper composite foil, and the current collector substrate has a thickness of 5 to 30 μm.

15. The battery of claim 13, wherein the self-healing conductive coating is a mixture of a self-healing material, an adhesive and a conductive filler, and the self-healing conductive coating has a coating thickness of 2 to 10 μm.

16. The battery of claim 13, comprising the following steps:
preparing microcapsules containing a healing agent;
preparing a slurry containing the microcapsules, a catalyst, an adhesive and a conductive filler;
coating the slurry on a surface of a current collector substrate to obtain a bipolar current collector with a self-healing conductive coating.

17. The battery of claim 16, wherein in the step of preparing the slurry containing the microcapsules, the catalyst, the adhesive and the conductive filler, the conductive filler is one or more of titanium powder, copper powder, aluminum powder, silver powder, lithium-rich silicon powder, and lithium-rich tin powder, or one or more of carbon black, carbon nanotube, carbon fiber, and graphene.

18. The battery of claim 16, wherein, in the step of preparing the slurry containing the microcapsules, the catalyst, the adhesive and the conductive filler, the adhesive is one or more of polyvinyl chloride, polyethylene, polypropylene, polystyrene, polytetrafluoroethylene, polyester terephthalate, polyamide, polyimide, polyether nitrile, polymethyl acrylate, polyvinylidene fluoride, polyurethane, polyacrylonitrile, styrene butadiene rubber, nitrile rubber, sodium carboxymethylcellulose, modified polyolefin, polyacetylene, polypyrrole and its derivatives, polythiophene and its derivatives, polyaniline and its derivatives, poly (p-phenylene vinylene) and its derivatives, polyparaphenylene and its derivatives, and polyfluorene and its derivatives.

19. The battery of claim 16, wherein in the step of preparing the slurry containing the microcapsules, the catalyst, the adhesive, and the conductive filler, the catalyst comprises one of molybdenum Schrock catalyst, ruthenium Grubbs catalyst, triethyl borane, diethylenetriamine, complex compound of copper bromide and 2-methylimidazole, scandium trifluoromethanesulfonate, tungsten hexachloride, and sodium dibutyl tin dilaurate.

20. The battery of claim 16, wherein, in the step of preparing the microcapsules containing the healing agent, the healing agent comprises one or more of cyclic olefin, lactone imine, acrylic acid, methacrylate, styrene, isoprene, 4,4′-methylenebis(phenyl isocyanate)/dicyclopentadiene and butadiene.
